(19) United States
(12) Patent Application Publication
(10) Pub. No.: US 2008/0149073 A1
(43) Pub. Date: Jun. 26, 2008

(54) FUEL INJECTION CONTROL APPARATUS

(75) Inventor: Hiroshi SETO, Yokohama-shi (JP)

Correspondence Address: GLOBAL IP COUNSELORS, LLP, 1233 20TH STREET, NW, SUITE 700, WASHINGTON, DC, 20036-2680, US

(73) Assignee: NISSAN MOTOR CO., LTD., Yokohama, Kanagawa (JP)

(21) Appl. No.: 11/957,700

(22) Filed: Dec. 17, 2007

(30) Foreign Application Priority Data
Dec. 20, 2006 (JP) 2006-342660

(51) Int. Cl. F02M 51/06

(52) U.S. Cl. 123/492

(57) ABSTRACT

A fuel injection control apparatus is provided with respect to a port-injection type engine that is configured to execute sequential fuel injection during normal operation and cut the fuel supply when a certain operating condition exists. The fuel injection control apparatus has a fuel injection control section that is configured such that upon determining that the deceleration rate of the engine speed is rapid when a fuel cut recovery condition is satisfied, then the fuel injection control section sets the fuel injection timings of the cylinders such that fuel is injected substantially simultaneously into at least a cylinder that was in an intake stroke and a cylinder that was in an exhaust stroke at the time when it was determined that the fuel cut recovery condition was satisfied.

### CROSS-REFERENCE TO RELATED APPLICATIONS

This application claims priority to Japanese Patent Application No. 2006-342660, filed on Dec. 20, 2006. The entire disclosure of Japanese Patent Application No. 2006-342660 is hereby incorporated herein by reference.

### BACKGROUND OF THE INVENTION

1. Field of the Invention

The present invention generally relates to a fuel injection control apparatus for an engine. More specifically, the present invention relates to a fuel injection control apparatus for improving combustion performance of an engine when the engine resumes combustion after the fuel supply has been cut during deceleration.

2. Background Information

Conventional known fuel injection control technology includes stopping the injection of fuel (cutting the fuel) when a prescribed fuel cut condition is satisfied during deceleration and resuming the injection of fuel (recovering from fuel cut) when a prescribed recovery condition is satisfied during the fuel cut state. This fuel cut operation during deceleration is designed to improve the fuel consumption performance of the engine. One example of this conventional fuel injection control technology is disclosed in Japanese Laid-Open Patent Publication No. 58-162734.

In view of the above, it will be apparent to those skilled in the art from this disclosure that there exists a need for an improved fuel injection control apparatus. This invention addresses this need in the art as well as other needs, which will become apparent to those skilled in the art from this disclosure.

### SUMMARY OF THE INVENTION

It has been discovered that in the technology described in Japanese Laid-Open Patent Publication No. 58-162734, the fuel cut recovery is executed in a manner that is contrived to reduce the sudden torque change that occurs when the engine resumes combustion. However, since the fuel injection control is executed in a manner that does not take into account the degree of deceleration, there is the possibility that the engine will stall when the fuel injection control is executed at a time when the deceleration is rapid.

One object of present invention is to provide a fuel injection control apparatus that can execute the fuel cut recovery in a manner that does not cause the engine to stall even if the deceleration is rapid.

Accordingly, a fuel injection control apparatus is provided for controlling injection of fuel into a plurality of air intake passages feeding into a plurality of cylinders of an engine. The fuel injection control apparatus basically comprises an operating state detecting section, a fuel cut determining section, a deceleration rate detecting section, a deceleration rate comparing section and a fuel injection control section. The operating state detecting section is configured to detect an engine operating state. The fuel cut determining section is configured to determine when a fuel cut start condition is satisfied for stopping fuel injection and when a fuel cut end condition for resuming fuel injection is satisfied based on the engine operating state. The deceleration rate detecting section is configured to detect a deceleration rate of an engine rotational speed during a fuel cutting state. The deceleration rate comparing section is configured to determine if the deceleration rate is equal to or higher than a prescribed deceleration rate. The fuel injection control section is configured to set a fuel injection quantity and a fuel injection timing based on the engine operating state. The fuel injection control section is further configured such that when the deceleration rate comparing section determines that the deceleration rate is smaller than the prescribed deceleration rate, then the fuel injection control section sets a sequential fuel injection timing in which fuel is injected into the cylinders sequentially after the fuel cut determining section determines that the fuel cut end condition is satisfied. The fuel injection control section is further configured such that when the deceleration rate comparing section determines that the deceleration rate is equal to or higher than the prescribed deceleration rate, then the fuel injection control section sets the fuel injection timing such that fuel injections occur in at least one of the cylinders that is in an intake stroke and at least one of the cylinders that is in an exhaust stroke substantially simultaneously with determination of the deceleration rate being equal to or higher than the prescribed deceleration rate.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a simplified schematic view of an engine with a fuel injection control apparatus in accordance with a first embodiment.

FIG. 2 is a flowchart showing a fuel injection control routine in accordance with the first embodiment that is executed at the time of a fuel cut recovery.

FIG. 3 is a timing chart with part (a) indicating the fuel injection timings for the cylinders with respect to the stroke, part (b) indicating the changes in the rapid deceleration determination flag, and part (c) indicating the pulse widths of the fuel injections that occur during execution of the control routine shown in FIG. 2 (first embodiment);

FIG. 4 is a flowchart showing a fuel injection control routine in accordance with a second embodiment that is executed at the time of a fuel cut recovery.

FIG. 5 is a timing chart with part (a) indicating the fuel injection timings for the cylinders with respect to the stroke, part (b) indicating the changes in the rapid deceleration determination flag, and part (c) indicating the pulse widths of the fuel injections that occur during execution of the control routine shown in FIG. 4 (first fuel cut recovery injection control for rapid deceleration in accordance with second embodiment);

FIG. 6 is a timing chart with part (a) indicating the fuel injection timings for the cylinders with respect to the stroke, part (b) indicating the changes in the rapid deceleration determination flag, and part (c) indicating the pulse widths of the fuel injections that occur during execution of the control routine shown in FIG. 4 (second fuel cut recovery injection control for rapid deceleration in accordance with second embodiment);

FIG. 7 is a flowchart showing a fuel injection control routine in accordance with a third embodiment that is executed at the time of a fuel cut recovery; and

FIG. 8 is a timing chart with part (a) indicating the fuel injection timings for the cylinders with respect to the stroke, part (b) indicating the changes in the rapid deceleration determination flag, part (c) indicating the pulse widths of the fuel injections that occur during execution of the control routine shown in FIG. 7, and part (d) indicating the relationships between the rotational speed deceleration rate and the determination threshold values that occur during execution of the control routine shown in FIG. 7 (third embodiment).

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

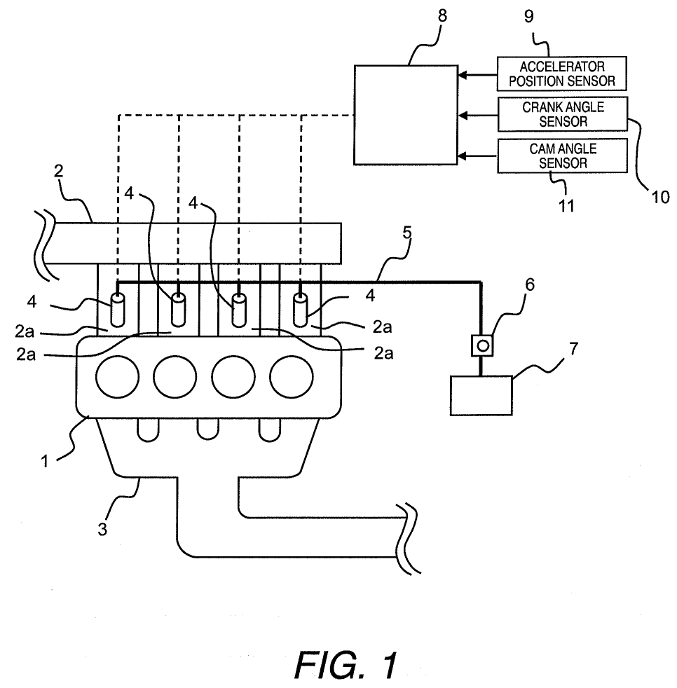

Referring initially to FIG. 1, a port-injection type engine 1 is schematically illustrated with a fuel injection control apparatus in accordance with a first embodiment of the present invention. The fuel injection control apparatus is configured to execute sequential fuel injection during normal operation and cut the fuel supply when a certain operating condition exists as explained below. The engine 1 has an intake manifold 2, an exhaust passage 3, a plurality of fuel injection valves 4, a fuel pipe 5, a fuel pump 6, a fuel tank 7, and an engine control unit (ECU) 8. The fuel injection valves 4 constitute a fuel injection device of the fuel injection control apparatus in the illustrated embodiment. The engine control unit 8 serves a controller that includes programming that constitutes a fuel injection control section, a fuel cut determining section and a deceleration rate comparing section of the fuel injection control apparatus in the illustrated embodiment.

The ECU 8 preferably includes a microcomputer with a fuel injection control program that controls the fuel injections as discussed below. The ECU 8 also preferably include other conventional components such as an input interface circuit, an output interface circuit, and storage devices such as a ROM (Read Only Memory) device and a RAM (Random Access Memory) device. The microcomputer of the ECU 8 is programmed to control the fuel injection valves 4. The memory circuit stores processing results and control programs such as ones for fuel injection operations that are run by the processor circuit. The internal RAM of the ECU 8 stores statuses of operational flags and various control data. The internal ROM of the ECU 8 stores various results and data for carrying out the fuel injection operations. The ECU 8 is capable of selectively controlling any of the components of the engine 1 as needed and/or desired. It will be apparent to those skilled in the art from this disclosure that the precise structure and algorithms for the ECU 8 can be any combination of hardware and software that will carry out the functions of the present invention.

As explained below, the ECU 8 is configured such that upon determining that the vehicle is decelerating rapidly when the fuel cut end condition or a fuel cut recovery condition is satisfied, then the fuel injection timings of the cylinders are set such that fuel is injected substantially simultaneously into at least a cylinder that was in an intake stroke and a cylinder that was in an exhaust stroke at the time when it was determined that the fuel cut recovery condition was satisfied without regards to a sequential fuel injection timing with which fuel is injected into the cylinders sequentially. As a result, stalling of the engine 1 is prevented when the engine 1 recovers from a fuel cut state while the engine speed is decelerating rapidly.

The intake manifold 2 includes a plurality of branches or runners 2a. A corresponding one of the branches 2a is connected to a corresponding one the cylinders of the engine 1. In the illustrated embodiment, the engine 1 is a four cylinder engine. The fuel injection valves 4 are arranged on the branches 2a, with one of the fuel injection valves 4 per one of the branches 2a so as to selectively inject fuel into each of the branches 2a towards the cylinders. Fuel pumped from the fuel tank 7 by the fuel pump 6 is supplied to the fuel injection valves 4 through the fuel pipe 5.

As seen in FIG. 1, an accelerator position sensor 9, a crank angle sensor 10, and a cam angle sensor 11 are provided to detect an operating state of the engine 1. Thus, the accelerator position sensor 9, the crank angle sensor 10, and the cam angle sensor 11 constitute an engine operating state detecting section of the fuel injection control apparatus. The sensors 9 to 11 are arranged to feed their detection values to the ECU 8. The ECU 8 is operatively coupled to the sensors 9 to 11 in a conventional manner. The ECU 8 calculates a fuel injection timing and a fuel injection quantity based on the detection values from the sensors 9 to 11 and sends the calculated fuel injection timing and fuel injection quantity to the fuel injection valves 4 as a fuel injection signal. The fuel injection valves 4 inject the fuel into the branches 2a in accordance with the fuel injection signal.

If the ECU 8 detects that the rotational speed of the engine 1 is decreasing more slowly than a prescribed deceleration rate, i.e., the engine operating conditions are normal, then the ECU 8 executes a so-called “sequential injection” in which fuel is injected into each cylinder when the cylinder is in the exhaust stroke. Also, when a prescribed operating condition is satisfied while the vehicle is traveling, the ECU 8 executes a so-called “fuel cut” in which the injection of fuel is stopped. The operating condition for executing the fuel cut (fuel cut condition) is, for example, that the accelerator has been released while the vehicle is moving and the engine speed is equal to or higher than a prescribed value (e.g., 1500 rpm). Additionally, when the engine speed becomes equal to or smaller than a prescribed value (e.g., 500 rpm) while the fuel is cut, the ECU 8 executes a so-called “fuel cut recovery” in which the injection of fuel is resumed.

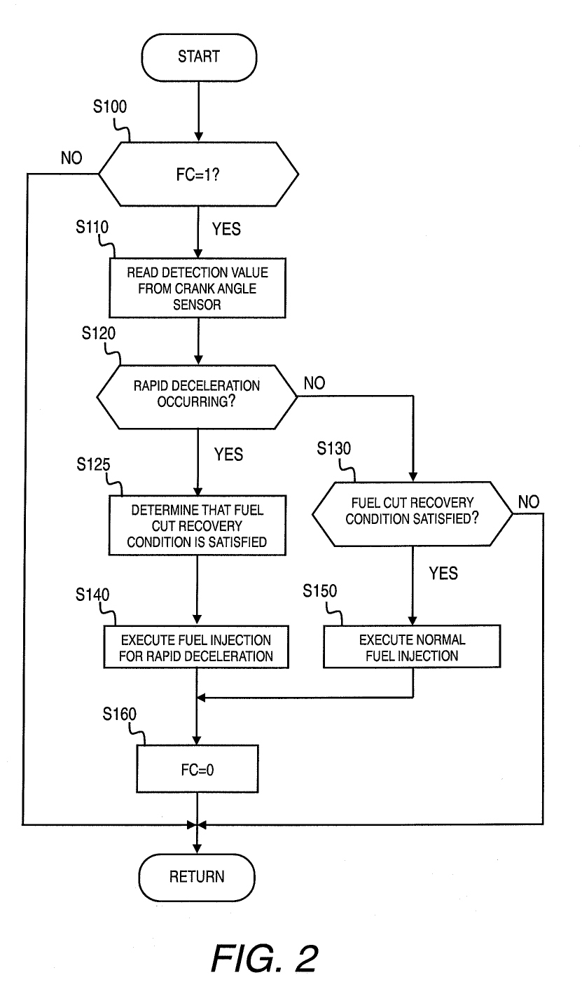

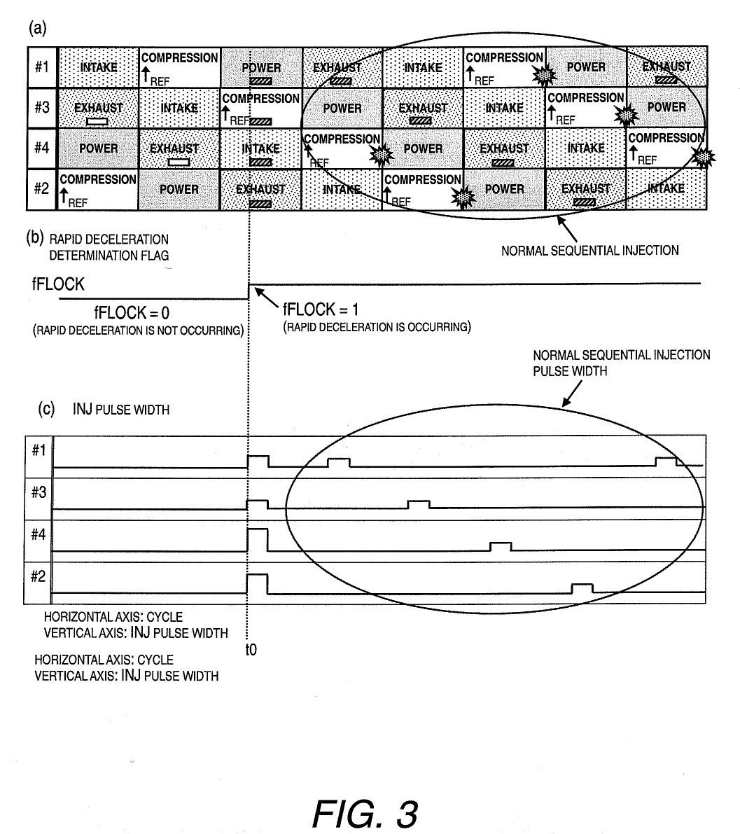

The fuel injection executed during a fuel cut recovery will now be explained with reference to FIGS. 2 and 3.

FIG. 2 is a flowchart showing a control routine for the fuel injection executed during a fuel cut recovery in accordance with this embodiment. This routine is executed once per fixed cyclical time period.

In step S100, the ECU 8 determines if engine 1 is currently in a fuel cut state, i.e., if the fuel supply to the engine 1 is currently cut. This determination is made by, for example, reading the value of a fuel cut flag FC. The fuel cut flag FC is set to 1 (FC=1) when the fuel cut condition is satisfied. The fuel cut flag FC is set to 0 (FC=0) when a fuel cut recovery condition is satisfied. If the engine 1 is in the fuel cut state, then the ECU 8 proceeds to step S110. Otherwise, the ECU 8 ends the routine.

In step S110, the ECU 8 reads a detection value from the crank angle sensor 10 and calculates a difference value ΔNe between the current engine speed Ne and the engine speed read in the previous cycle.

In step S120, based on the engine speed difference ΔNe calculated in step S110, the ECU 8 determines if the deceleration rate of the engine speed is higher than a prescribed deceleration rate. The prescribed deceleration rate is a threshold value for determining if the rate of change per unit time of the engine rotational speed is rapid. The prescribed deceleration rate (threshold value) is set in advance based on the specifications of the engine 1 and the transmission that will be used in the vehicle. The prescribed deceleration rate (threshold value) is set to such a value that the engine 1 will not stall when the fuel cut recovery is executed (e.g., 200 rpm/10 mmsec). The deceleration rate comparing section of the ECU 8 can also be realized by detecting the output shaft rotational speed of the transmission (not shown) and determining if rapid deceleration is occurring based on a difference between output shaft rotational speeds. Additionally, if the transmission is locked (connected directly), then the rotational speed of the engine can also decrease when the wheel speed decelerates and the vehicle speed decreases due to the engine being rotated by the rotation of the wheels. In this situation, it is acceptable to detect the deceleration rate of the vehicle itself with an acceleration gauge and estimate the rate of decrease of the engine speed based on the detected deceleration rate.

If the difference ΔNe is smaller than the threshold value (if the absolute value is large), then the ECU 8 determines that the deceleration is rapid. If the ECU 8 determines that the deceleration is rapid, then the ECU 8 proceeds to step S125 and sets a deceleration determination flag fFLOCK to 1 to indicate that the fuel cut recovery condition is satisfied. The ECU 8 then proceeds to step S140. If the ECU 8 determines that the deceleration is not rapid, then the ECU 8 sets the deceleration determination flag fFLOCK to zero and proceeds to step S130.

In step S130, the ECU 8 determines if the fuel cut recovery condition is satisfied. This determination is accomplished by, for example, setting a lower limit value Nemin of the engine speed at which the fuel cut state can be continued and determining if the engine rotational speed Ne calculated in step S110 is equal to or smaller than the lower limit value Nemin. If the engine speed Ne is equal to or smaller than the lower limit value Nemin, then the ECU 8 determines that the fuel cut recovery condition is satisfied.

If the ECU 8 determines that the fuel cut recovery condition is satisfied, the ECU 8 proceeds to step S150. Otherwise, the ECU 8 ends the routine.

In step S150, since the deceleration rate is not equal to or higher than the prescribed deceleration rate, i.e., since the deceleration is not rapid, the ECU 8 starts executing fuel injection at the regular sequential injection timing. In other words, after the fuel cut recovery condition is satisfied, the ECU 8 executes the fuel injection in the same manner as during normal operation.

In step S140, the ECU 8 executes a fuel cut recovery injection (explained later) tailored for rapid deceleration.

After the fuel cut recovery is executed in step S140 or S150, the ECU proceeds to step S160 and sets the fuel cut flag FC to zero before ending the routine.

The fuel cut recovery injection tailored for rapid deceleration will now explained with reference to FIG. 3. Part (a) of the timing chart of FIG. 3 indicates the fuel injection timings executed when the control routine shown in FIG. 2 is executed. Part (b) of the timing chart of FIG. 3 indicates the value of the rapid deceleration determination flag during execution of the same control routine. Part (c) of the timing chart of FIG. 3 indicates the injection pulse widths that occur during execution of the same control routine. In part (c) of the timing chart of FIG. 3, the pulse width is expressed as a height. Parts (a) to (c) of the timing chart of FIG. 3 all illustrate a case in which the fuel cut recovery condition is satisfied at a time t0 and the acceleration is determined to be rapid.

As shown in parts (a) to (c) of the timing chart of FIG. 3, at the time t0 the value of the rapid deceleration determination flag fFLOCK changes to 1 because the fuel cut recover condition is satisfied. Fuel is injected into all of the cylinders #1 to #4 without relation to the normal sequential fuel injection timing. Afterwards, normal sequential fuel injection starts when the cylinder that was in the power stroke when the fuel cut recovery condition was satisfied reaches the exhaust stroke.

At the time that fuel cut recover condition is satisfied, since fuel is injected into the cylinder that is in the intake stroke, i.e., the #4 cylinder, injected fuel is supplied immediately to a combustion chamber and the time from when the fuel cut recovery condition is satisfied until the first combustion occurs can be shortened. Also, since the fuel injected into the cylinder that is in the exhaust stroke, i.e., the #2 cylinder, has at least as much time to atomize as when fuel is injected at a normal sequential injection timing, the second combustion that occurs after the fuel cut recovery condition is satisfied is executed with fuel that is well atomized.

As described above, torque is produced with the #4 cylinder at an early stage and the combustion that occurs in the #2 cylinder is conducted with well-atomized fuel. Therefore, compared to a conventional fuel injection control apparatus in which the fuel injection is started with sequential fuel injection timing after the fuel cut recovery condition is satisfied, the possibility of the engine stalling can be reduced and the combustion performance can be improved.

Furthermore, since fuel is injected into the cylinder that is in the power stroke (#1 cylinder) and the cylinder that is in the compression stroke (#3 cylinder), the fuel injected into these cylinders is able to atomize for a longer period of time than during normal sequential injection, and thus, the combustion performance of the third and fourth combustions executed after the fuel cut recovery condition is satisfied can be also be improved.

Additionally, the fuel injections executed during a fuel cut recovery tailored for rapid deceleration are executed such that the amount of fuel injected into the #4 cylinder is the largest. As shown in part (c) of the timing chart of FIG. 3, the cylinders have the following relationship when arranged in order from largest injection quantity to smallest fuel injection quantity: #4 cylinder>#2 cylinder>#1 cylinder>#3. In other words, the fuel injection quantity of the cylinder in the intake stroke>the fuel injection quantity of the cylinder in the exhaust stroke>the fuel injection quantity of the cylinder in the power stroke>the fuel injection quantity of the cylinder in the compression stroke.

The reason the amount of fuel injected into the cylinder that is in the intake stroke is the largest is because fuel injected during the intake stroke will have little time to atomize (atomization time) before it is combusted. Thus, to compensate for the lack of sufficient atomization time, the fuel injection quantity is increased such that a sufficient quantity of fuel can be supplied to the combustion chamber.

The reason the quantities of fuel injected into the cylinder in the power stroke and the cylinder in the compression stroke are smaller than the quantity of fuel injected into the cylinder in the exhaust stroke is because the fuel injected into these cylinders is able to atomize for a longer period of time.

Additionally, as indicated by the pulse widths shown in part (c) of the timing chart of FIG. 3, even the quantity of fuel injected into the cylinder that is in the compression stroke, which is the smallest quantity of all the fuel injections executed simultaneously with the satisfaction of the fuel cut recovery condition, is larger than the quantities of fuel injected during normal sequential fuel injection. The reason for using larger fuel injection quantities is to achieve a richer fuel mixture than normal sequential injection and improve the combustion performance.

The fuel cut recovery fuel injections should be executed with respect to at least the cylinder that is in the intake stroke and the cylinder that is in the exhaust stroke when the fuel cut recovery condition is satisfied.

The effects that can be obtained with this embodiment will now be explained.

If the ECU 8 determines that the deceleration rate is normal when the fuel cut recovery condition is satisfied, then the ECU 8 sets the fuel injection timings such that fuel is injected into each cylinder sequentially when each cylinder is in the exhaust stroke. Meanwhile, if the ECU 8 determines that the deceleration rate is rapid when the fuel cut recovery condition is satisfied, then the ECU 8 sets the fuel injection timings such that the fuel injections of at least the cylinder that is in the intake stroke and the cylinder that is in the exhaust stroke at the time when it is determined that the deceleration is rapid occur substantially simultaneously with the determination that the fuel cut recovery condition is satisfied without regards to a normal sequential fuel injection timing with which fuel is injected into the cylinders sequentially.

With a fuel injection control apparatus contrived execute the fuel cut recovery by injecting fuel at sequential injection timings that are the same as are used during normal driving, there are situations in which it takes time for the injection of fuel to resume after the fuel cut recovery condition is satisfied and if the rate at which the engine speed is decreasing is large, such as during rapid deceleration, then the engine speed will decrease by a large amount between when the fuel cut recovery condition is satisfied and when the fuel injection resumes. Thus, there is the possibility that the engine will stall. Conversely, since this embodiment shortens the amount of time between when the fuel cut end condition is satisfied and when the first combustion occurs, torque can be generated at an earlier stage and a sufficient fuel atomization time can be secured for the cylinder in which the next (second) combustion occurs. As a result, even when the deceleration is rapid, the fuel cut recovery can be executed such that the engine does not stall.

When a fuel cut recovery is executed in a situation in which it has been determined that the deceleration is rapid, the fuel injection quantities injected during the fuel cut recovery are set such that the quantity of fuel injected into the cylinder that is in the intake stroke is the largest and the quantities of fuel injected into the other cylinders are successively smaller in the following order from largest to smallest: the cylinder that is in the exhaust stroke, the cylinder that is in the power stroke, and the cylinder that is in the compression stroke. Thus, torque can be reliably generated from the first ignition that occurs after the fuel cut recovery condition is satisfied without injecting fuel unnecessarily or degrading the fuel efficiency. As a result, engine stalling can be prevented.

### Second Embodiment

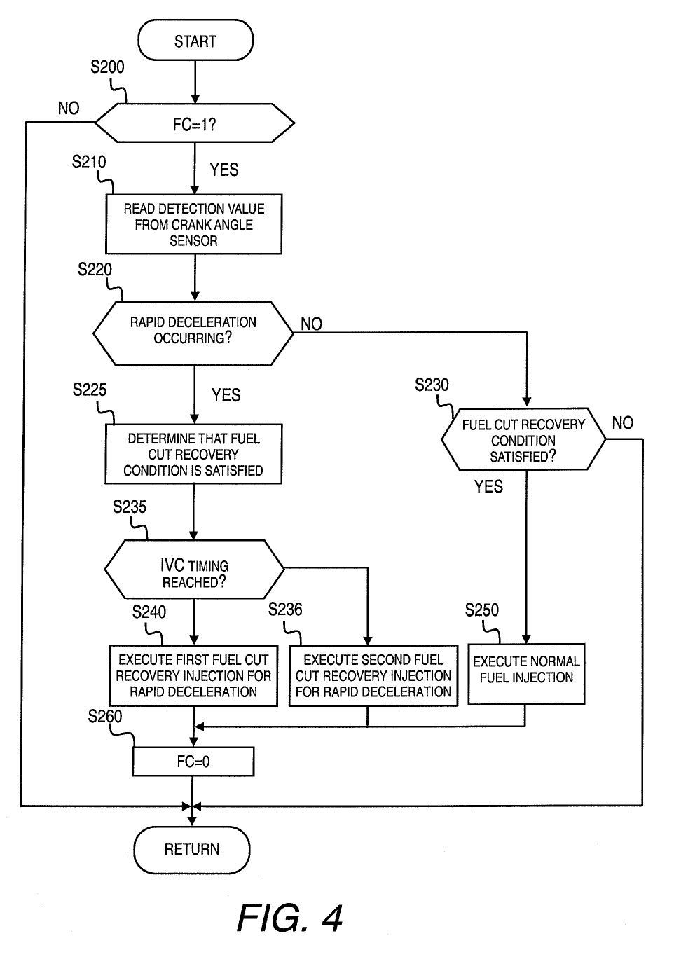

Referring now to FIGS. 4 to 6, a fuel injection control apparatus in accordance with a second embodiment will now be explained. The system configuration of FIG. 1 is the same in the first and second embodiments. The fuel injection control of the second embodiment is basically the same as in the first embodiment, except that the fuel injection control executed during a fuel cut recovery is different. In view of the similarity between the first and second embodiments, the descriptions of the parts of the second embodiment that are identical to the parts of the first embodiment may be omitted for the sake of brevity.

The fuel injection control executed during a fuel cut recovery in accordance with this embodiment will now be explained with reference to FIGS. 4 to 6. FIG. 4 is a flowchart showing a control routine for the fuel injection executed during a fuel cut recovery. This routine is executed once per fixed time period.

Steps S200 to S230, S250, and S260 of FIG. 4 are the same as steps S100 to S130, S150, and S160 of FIG. 2. Therefore, the explanations of these steps are omitted for the sake of brevity. In step S210, however, the detection value of the cam angle sensor 11 is read instead of the detection value of the crank angle sensor 10.

If the ECU 8 determines that the deceleration is rapid in step S220 and the fuel cut recovery condition is satisfied in step S225, then the ECU 8 proceeds to step S235 and determines if the fuel cut recovery condition was satisfied before the intake valve close timing (IVC). The determination as to whether or not the fuel cut recovery condition was satisfied before the IVC timing is made based on the detection value of the cam angle sensor 11 read in step S210.

If it determines in step S235 that the fuel cut recovery condition was satisfied before the IVC timing, then the ECU 8 proceeds to step S240 and executes a fuel cut recovery injection control tailored for a case in which the deceleration is rapid and the fuel cut recovery condition was satisfied before the IVC timing (this injection control is called a first fuel cut recovery injection for rapid deceleration).

If it determines that the fuel cut recovery condition was satisfied at or after the IVC timing, then the ECU 8 proceeds to step S236. In step S236, the ECU 8 executes a fuel cut recovery injection control tailored for a case in which the deceleration is rapid and the fuel cut recovery condition was satisfied at or after the IVC timing (this injection control is called a second fuel cut recovery injection for rapid deceleration).

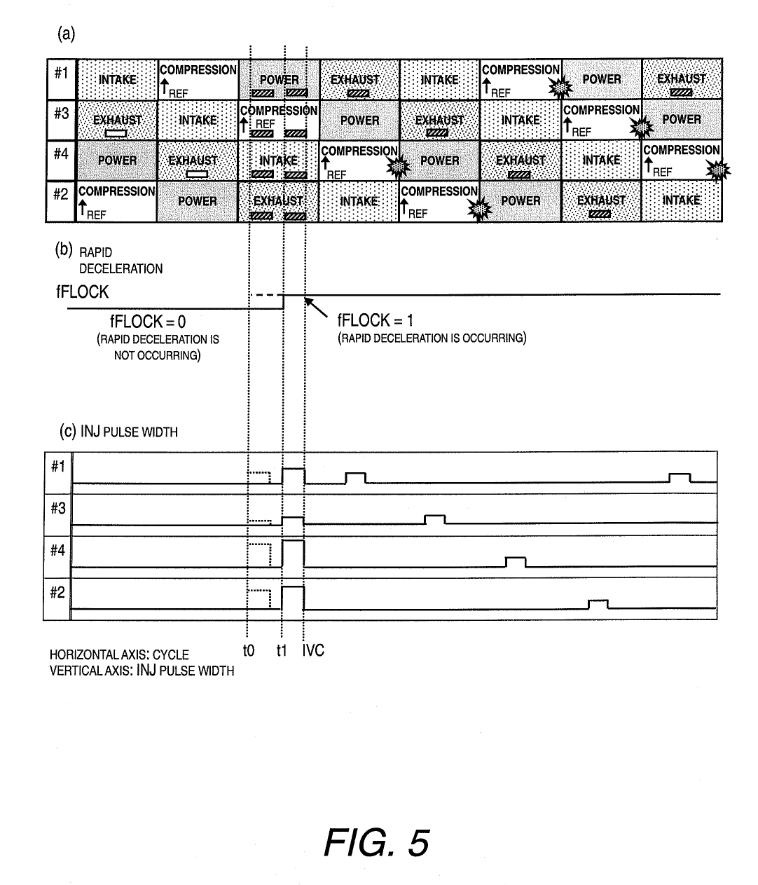

The first fuel cut recovery injection tailored for rapid deceleration will now explained with reference to parts (a) to (c) of the timing chart of FIG. 5. Parts (a) to (c) of the timing chart of FIG. 5 indicate the fuel injection timing, the rapid deceleration determination flag, and the fuel injection pulse width in the same manner as parts (a) to (c) of the timing chart of FIG. 3. The broken lines in parts (a) to (c) of the timing chart of FIG. 5 indicates a case in which the deceleration is determined to be rapid and the fuel cut recovery condition is determined be satisfied at a time t0 occurring before the IVC timing. The solid lines indicate a case in which, similarly, the deceleration is determined to be rapid and the fuel cut recovery condition is determined to be satisfied at a time occurring after the time t0 and before the IVC timing.

If the determination that the deceleration is rapid and the determination that the fuel cut recovery condition is satisfied occur at the time t0, then, similarly to the first embodiment, the fuel injection quantity injected into cylinder that is in the intake stroke is the largest and the quantities of fuel injected into the other cylinders are successively smaller in the following order from largest to smallest: the cylinder that is in the exhaust stroke, the cylinder that is in the power stroke, and the cylinder that is in the compression stroke.

If the determination that the deceleration is rapid and the determination that the fuel cut recovery condition is satisfied occur at the time t1, then the relative size relationships among the fuel injection quantities of the cylinders are similar to when the same determinations occur at the time t0. In other words, the fuel injection quantities have the following relationship: the fuel injection quantity of the cylinder in the intake stroke>the fuel injection quantity of the cylinder in the exhaust stroke>the fuel injection quantity of the cylinder in the power stroke>the fuel injection quantity of the cylinder in the compression stroke. However, as shown in part (c) of the timing chart of FIG. 5, the fuel injection quantities of each cylinder are larger than in the case where said determinations occur at the time t0.

Thus, the closer the time when the fuel cut recovery condition is satisfied is to the IVC timing, the larger the fuel injection amounts of each cylinder are set to be.

The closer the time when the fuel cut recovery condition is satisfied is to the IVC timing, the shorter the amount of time until spark ignition is and the shorter the atomization time is. As a result, the combustion performance declines. Therefore, the fuel injection quantities are increased to enrich the air-fuel ratio and ensure a sufficient combustion performance.

It is not imperative to adjust the fuel injection quantities of all of the cylinders in accordance with the amount of time between the satisfaction of the fuel cut recovery condition and the occurrence of IVC. It is sufficient to adjust at least the fuel injection quantity of the cylinder that is in the intake stroke.

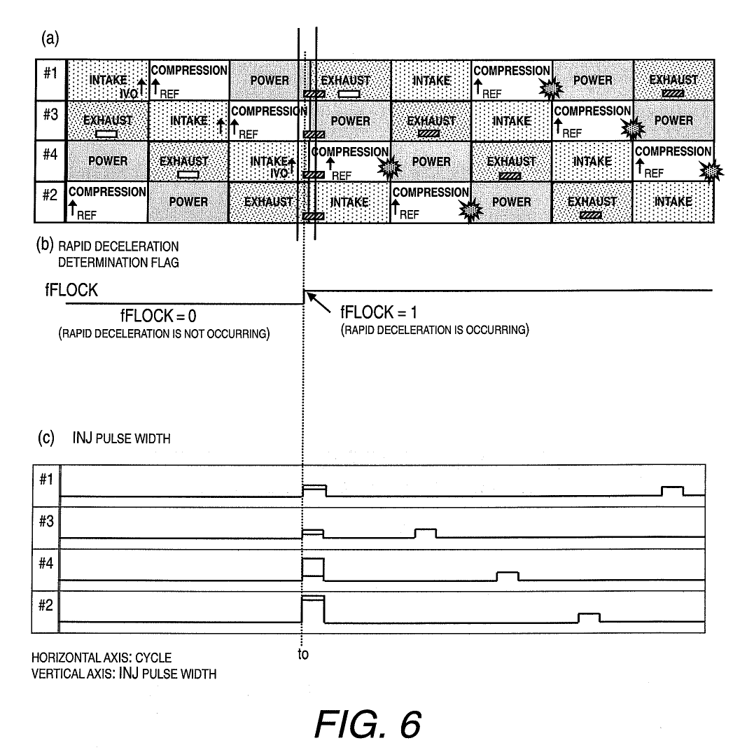

The second fuel cut recovery injection tailored for rapid deceleration will now explained with reference to parts (a) to (c) of the timing chart of FIG. 6. Parts (a) to (c) of the timing chart of FIG. 6 indicate the fuel injection timing, the rapid deceleration determination flag, and the fuel injection pulse width in the same manner as parts (a) to (c) of the timing chart of FIG. 3. Parts (a) to (c) of the timing chart of FIG. 6 illustrate a case in which the deceleration is determined to be rapid and the fuel cut recovery condition is determined to be satisfied at a time t0 occurring at or after the IVC timing.

In this case, fuel is still injected into all of the cylinders simultaneously with the determination that the fuel cut recovery condition is satisfied, but the relative size relationships among the fuel injection quantities of the cylinders are different from when the determinations occur at a time t0 occurring before the IVC timing. In other words, the fuel injection quantities have the following relationship when listed in order from the cylinder receiving the largest fuel injection quantity to the cylinder receiving the smallest: #2>#1>#3>#4, i.e., the fuel injection quantity of the cylinder in the exhaust stroke>the fuel injection quantity of the cylinder in the power stroke>the fuel injection quantity of the cylinder in the compression stroke>the fuel injection quantity of the cylinder in the intake stroke.

The reason for this relationship is that fuel injected with respect to the cylinder that is in the intake stroke will not enter the cylinder if the intake valve is already closed. Therefore, the quantity of fuel injected to the cylinder that is in the intake stroke when the fuel cut recovery condition is satisfied is set to a small quantity and the quantity of fuel injected into the cylinder that is in the exhaust stroke is set to be large. Since the cylinder in the exhaust stroke will soon enter the intake stroke, torque can be generated at an earlier stage by injecting a larger quantity of fuel into the cylinder that is in the exhaust stroke. Meanwhile, similarly to the first embodiment, the quantities of fuel injected into the cylinders in the power stroke and the compression stroke are set to be smaller in accordance with the length of atomization time that the fuel injected to each of those cylinders will have, i.e., the longer the atomization time, the smaller the fuel injection quantity.

After the fuel cut recovery condition is satisfied, sequential fuel injection starts when the cylinder that was in the compression stroke when the fuel cut recovery condition was satisfied (i.e., the #3 cylinder) enters the exhaust stroke. The reason the sequential fuel injection is started at that point is that the cylinder that was in the power stroke when the fuel cut recovery condition was satisfied, i.e., the #1 cylinder, has received a sufficient quantity of injected fuel during the power stroke.

The effects that can be obtained with this embodiment in addition to the effects obtained with the first embodiment will now be explained.

In the second embodiment, if the ECU 8 makes the determination that the rate at which the engine rotational speed is decreasing is higher than a prescribed rate, i.e., that the deceleration is rapid, at a point in time occurring after the intake valve close timing (IVC) of the cylinder in the intake stroke is reached, then the ECU 8 assumes that the fuel cut recovery condition was satisfied at the time when it determined that the rate at which the engine rotational speed is decreasing was higher than a prescribed rate (i.e., that the deceleration was rapid) and sets the fuel injection quantities used in the fuel cut recovery such that the quantity of fuel injected into the cylinder that is in the exhaust stroke is the largest and the quantities of fuel injected into the other cylinders are successively smaller in the following order from largest to smallest: the cylinder that is in the power stroke, the cylinder that is in the compression stroke, and the cylinder that is in the intake stroke. Furthermore, the quantity of fuel injected into the cylinder that is in the exhaust stroke is set to be substantially equal to the quantity of fuel that would have been injected into the cylinder that is in the intake stroke if the determinations that the deceleration is rapid and that the fuel cut recovery condition is satisfied had occurred before the IVC timing of the cylinder that is in the intake stroke, and the quantity of fuel injected into the cylinder that is in the power stroke is set to be substantially equal to the quantity of fuel that would have been injected into the cylinder that is in the exhaust stroke if the determinations that the deceleration is rapid and that the fuel cut recovery condition is satisfied had occurred before the IVC timing of the cylinder that is in the intake stroke. As a result, an appropriate fuel injection quantity can be set for each cylinder such that engine stalling can be prevented.

Additionally, in the second embodiment, if the ECU 8 makes the determinations that the deceleration is rapid and that the fuel cut recovery condition is satisfied at a point in time occurring before the intake valve close timing (IVC) of the cylinder in the intake stroke is reached, then the ECU 8 sets at least the fuel injection quantity of the cylinder that is in the intake stroke to be larger in accordance with how close the time when said determinations were made is to the IVC timing. In other words, the shorter the amount of time between when the determinations were made and when the IVC timing is reached, the larger the value to which fuel injection quantity is set, at least with respect to the cylinder in the intake stroke. As a result, even though the available atomization time is shorter when the fuel cut recovery injection timing is closer to the IVC timing, sufficient combustion performance can be secured and engine stalling can be prevented.

### Third Embodiment

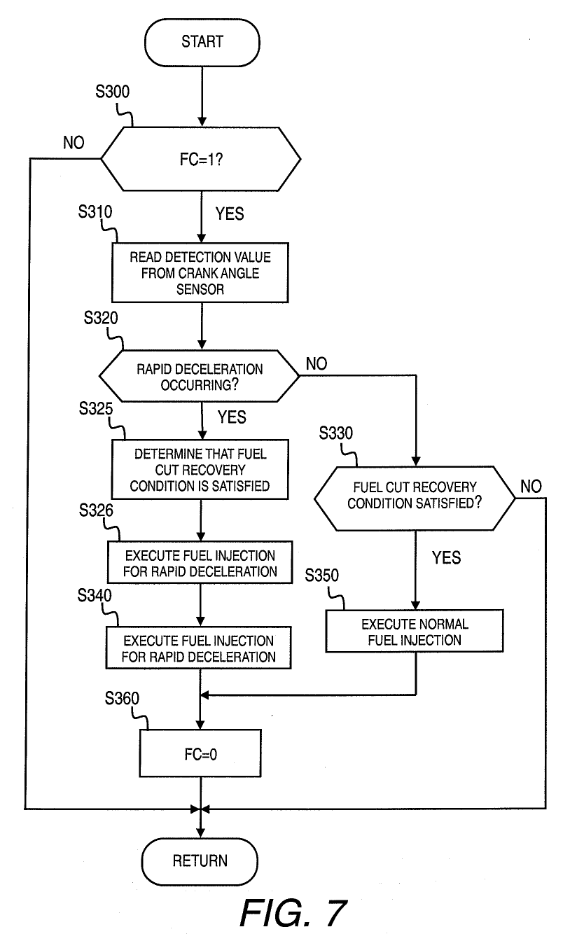

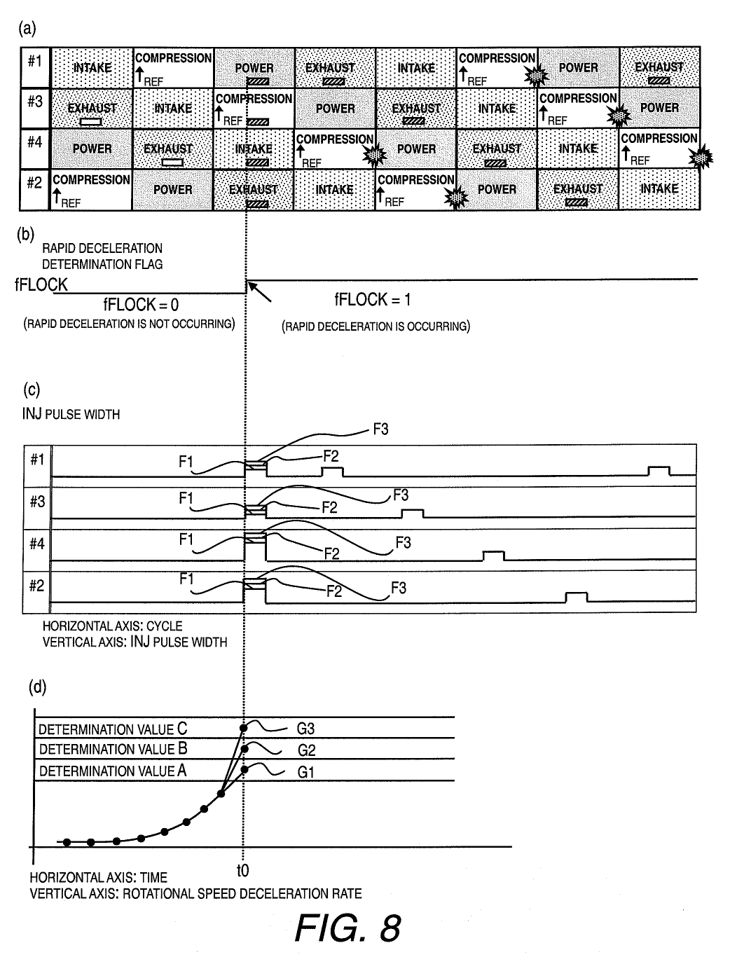

Referring now to FIGS. 7 and 8, a fuel injection control apparatus in accordance with a third embodiment will now be explained. The system configuration of FIG. 1 is the same in the first and third embodiments. The fuel injection control executed at the time of a fuel cut recovery of the third embodiment is basically the same as in the first embodiment, except that the fuel injection quantities injected during a fuel cut recovery executed under rapid deceleration conditions are different. In view of the similarity between the first and third embodiments, the descriptions of the parts of the third embodiment that are identical to the parts of the first embodiment may be omitted for the sake of brevity.

A fuel cut recovery fuel injection control in accordance with the third embodiment will now be explained with reference to FIGS. 7 and 8.

FIG. 7 is a flowchart showing a fuel injection control routine in accordance with this embodiment that is executed at the time of a fuel cut recovery.

Steps S300, S310, S325, S330, S350, and S360 are the same as the steps S100, S110, S125, S130, S150, and S160 of the flowchart shown in FIG. 2. Therefore, the explanations of these steps are omitted for the sake of brevity.

Step S320 is the same as the step S120 of the first embodiment in that the determination as to whether or not the deceleration is rapid is made using a rotational speed deceleration rate calculated based on a detection valve from a crank angle sensor. However, in this embodiment, a plurality of determination threshold values are set in advance and the deceleration is determined to be rapid if the calculated deceleration rate is higher than the smallest determination threshold value.

If the deceleration is determined to be rapid in step S320, the ECU 8 proceeds to step S325 and establishes that the fuel cut recovery condition is satisfied before proceeding to step S326.

In step S326, the ECU 8 reads the rotational speed deceleration rate used in step S320 and proceeds to step S340.

If it determines in step S320 that the deceleration is not rapid, then the ECU 8 proceeds to step S330 where it executes the same control processing as in step S130 of FIG. 2.

In step S340, the ECU 8 sets the fuel injection quantities in accordance with the deceleration rate and executes the fuel cut recovery injections.

The determination of whether the deceleration is rapid made in step S320 and the setting of the fuel injection quantities executed in step S340 will now be explained with reference to parts (a) to (d) of the timing chart of FIG. 8. Similarly to parts (a) to (c) of the timing chart of FIG. 3, parts (a) to (c) of the timing chart of FIG. 8 illustrate the fuel injection cycle, the rapid deceleration determination flag, and the fuel injection pulse. Part (d) of the timing chart of FIG. 8 illustrates the relationships between the rotational speed deceleration rate and the determination threshold values. The reference numerals F1 to F3 used in part (c) of the timing chart of FIG. 8 indicate the fuel injection quantities corresponding to the situations indicated as G1 to G3 in part (d) of the timing chart of FIG. 8. The determination threshold values A to C are threshold values used to determine if the deceleration is rapid.

As shown in the figures, when three threshold values A to C (A<B<C) are set asset as determination threshold values to which the rotational speed deceleration rate is compared, the deceleration is determined to be rapid if the rotational speed deceleration rate is higher than the smallest determination threshold value A.

The higher the rotational speed deceleration rate is, the shorter the amount of time required for the engine speed to decline to a point where the engine will stall and, thus, the shorter the amount of time that can be allowed to pass from when the fuel cut recovery condition is satisfied until when the first ignition of the recovery occurs. Consequently, the amount of time available for the fuel injected for the fuel cut recover to atomize is also shorter. Therefore, the fuel injection quantities F1, F2, and F3 are set to be consecutively larger in accordance with the consecutively higher rotational speed deceleration rates G1, G2, G3 in order to enrich the air-fuel ratio and ensure a sufficient combustion performance.

The effects that can be obtained with this embodiment in addition to the effects obtained with the first and second embodiments will now be explained.

Since the ECU 8 sets the fuel quantities injected during a fuel cut recovery to be larger when the rotational speed deceleration rate is larger, a sufficient combustion performance can be ensured and engine stalling can be prevented even if the atomization time is short due to the rotational speed deceleration rate being large.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. The term “detect” as used herein to describe an operation or function carried out by a component, a section, a device or the like includes a component, a section, a device or the like that does not require physical detection, but rather includes determining, measuring, modeling, estimating, predicting or computing or the like to carry out the operation or function. The term “configured” as used herein to describe a component, section or part of a device includes hardware and/or software that is constructed and/or programmed to carry out the desired function. The terms of degree such as “substantially”, “about” and “approximately” as used herein mean a reasonable amount of deviation of the modified term such that the end result is not significantly changed. For example, the term “substantially simultaneously” as used in connection with the fuel injection timings refers to the fuel injections that occur at least partially simultaneously or at least within the same portion of the stroke (i.e., within the same exhaust stroke, the same intake stroke, the same compression stroke or the same power stroke).

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A fuel injection control apparatus for controlling injection of fuel into a plurality of air intake passages feeding into a plurality of cylinders of an engine, the fuel injection control apparatus comprising:
an operating state detecting section configured to detect an engine operating state;
a fuel cut determining section configured to determine when a fuel cut start condition is satisfied for stopping fuel injection and when a fuel cut end condition for resuming fuel injection is satisfied based on the engine operating state;
a deceleration rate detecting section configured to detect a deceleration rate of an engine rotational speed during a fuel cutting state;
a deceleration rate comparing section configured to determine if the deceleration rate is equal to or higher than a prescribed deceleration rate; and
a fuel injection control section configured to set a fuel injection quantity and a fuel injection timing based on the engine operating state, the fuel injection control section being further configured such that:
when the deceleration rate comparing section determines that the deceleration rate is smaller than the prescribed deceleration rate, then the fuel injection control section sets a sequential fuel injection timing in which fuel is injected into the cylinders sequentially after the fuel cut determining section determines that the fuel cut end condition is satisfied; and
when the deceleration rate comparing section determines that the deceleration rate is equal to or higher than the prescribed deceleration rate, then the fuel injection control section sets the fuel injection timing such that fuel injections occur in at least one of the cylinders that is in an intake stroke and at least one of the cylinders that is in an exhaust stroke substantially simultaneously with determination of the deceleration rate being equal to or higher than the prescribed deceleration rate.

2. The engine fuel injection control apparatus as recited in claim 1, wherein the fuel injection control section is further configured such that:
when the deceleration rate comparing section has determined that the deceleration rate is equal to or higher than the prescribed deceleration rate, then the fuel injection control section sets the fuel injection quantity for the cylinder that is in the intake stroke to be larger than the fuel injection quantity for the cylinder that is in the exhaust stroke.

3. The engine fuel injection control apparatus as recited in claim 1, wherein the fuel injection control section is further configured such that:
when the deceleration rate comparing section has determined that the deceleration rate is equal to or higher than the prescribed deceleration rate, then the fuel injection control section sets the fuel injection timings such that fuel is injected into all of the cylinders substantially simultaneously with the determination that the deceleration rate is equal to or higher than the prescribed deceleration rate.

4. The engine fuel injection control apparatus as recited in claim 3, wherein the fuel injection control section is further configured such that:
when the deceleration rate comparing section has determined that the deceleration rate is equal to or higher than the prescribed deceleration rate, then the fuel injection control section sets the fuel injection quantity for the cylinder that is in the intake stroke to be larger than the fuel injection quantities for the cylinders that are in non-intake strokes, and sets the fuel injection quantities for the cylinders that are in the non-intake strokes to be successively smaller in a following order from largest quantity to smallest quantity: the cylinder that is in the exhaust stroke, the cylinder that is in a power stroke, and the cylinder that is in a compression stroke.

5. The engine fuel injection control apparatus as recited in claim 4, wherein the fuel injection control section is further configured such that:
when the deceleration rate comparing section has determined that the deceleration rate is equal to or higher than the prescribed deceleration rate and an intake valve of the cylinder that is in the intake stroke is already closed, the fuel injection control section sets the fuel injection quantity for the cylinder that is in the exhaust stroke to be larger than the fuel injection quantity for the cylinders that are in non-exhaust strokes, and sets the fuel injection quantities for the cylinders that are in the non-exhaust strokes to be successively smaller in a following order from largest quantity to smallest quantity: the cylinder that is in the power stroke, the cylinder that is in the compression stroke, and the cylinder that is in the intake stroke:

6. The engine fuel injection control apparatus as recited in claim 5, wherein the fuel injection control section is further configured such that:
when the deceleration rate comparing section has determined that the deceleration rate is equal to or higher than the prescribed deceleration rate and an intake valve of the cylinder that is in the intake stroke is already closed, the fuel injection control section sets the fuel injection quantity for the cylinder that is in the exhaust stroke to be substantially equal to the fuel injection quantity that would have been injected into the cylinder that is in the intake stroke if the intake valve had not already been closed, and sets the fuel injection quantity for the cylinder that is in the power stroke to be substantially equal to the fuel injection quantity that would have been injected into the cylinder that is in the exhaust stroke if the intake valve had not yet been closed.

7. The engine fuel injection control apparatus as recited in claim 1, wherein the fuel injection control section is further configured such that:
when the deceleration rate comparing section has determined that the deceleration rate is equal to or higher than the prescribed deceleration rate and an intake valve of the cylinder that is in the intake stroke is not yet closed, the fuel injection control section sets the fuel injection quantity for the cylinder that is in the intake stroke to become larger as a period of time measured from the determination that the deceleration rate is equal to or higher than the prescribed deceleration rate to when the intake valve close timing is reached becomes shorter.

8. The engine fuel injection control apparatus as recited in claim 1, wherein
the deceleration rate detecting section is configured to calculate the deceleration rate based on a rate of change of at least one of the engine rotational speed and an output shaft rotational speed of a transmission.

9. A fuel injection control method comprising:
detecting section an engine operating state of an engine having a fuel injection device configured to inject fuel into a plurality of air intake passages feeding into a plurality of cylinders of the engine;
determining when a fuel cut start condition is satisfied for stopping fuel injection and when a fuel cut end condition for resuming fuel injection is satisfied based on the engine operating state;
detecting a deceleration rate of an engine rotational speed during a fuel cutting state;
determining if the deceleration rate is equal to or higher than a prescribed deceleration rate; and
setting a fuel injection quantity and a fuel injection timing based on the engine operating state such that:
upon determining that the deceleration rate is smaller than the prescribed deceleration rate, a sequential fuel injection timing is set in which fuel is injected into the cylinders sequentially after determining that the fuel cut end condition has been satisfied; and
upon determining that the deceleration rate is equal to or higher than the prescribed deceleration rate, the fuel injection timing is set such that fuel injections occur in at least one of the cylinders that is in an intake stroke and at least one of the cylinders that is in an exhaust stroke substantially simultaneously with determination of the deceleration rate being equal to or higher than the prescribed deceleration rate.

10. The engine fuel injection control method as recited in claim 9, wherein
upon determining that the deceleration rate is equal to or higher than the prescribed deceleration rate, then the fuel injection quantity for the cylinder that is in the intake stroke is set to be larger than the fuel injection quantity for the cylinder that is in the exhaust stroke.

11. The engine fuel injection control method as recited in claim 9, wherein
upon determining that the deceleration rate is equal to or higher than the prescribed deceleration rate, then the fuel injection timings is set such that fuel is injected into all of the cylinders substantially simultaneously with the determination that the deceleration rate is equal to or higher than the prescribed deceleration rate.

12. The engine fuel injection control method as recited in claim 11, wherein
upon determining that the deceleration rate is equal to or higher than the prescribed deceleration rate, then the fuel injection quantity for the cylinder that is in the intake stroke is set to be larger than the fuel injection quantities for the cylinders that are in non-intake strokes, and the fuel injection quantities for the cylinders that are in the non-intake strokes are set to be successively smaller in a following order from largest quantity to smallest quantity: the cylinder that is in the exhaust stroke, the cylinder that is in a power stroke, and the cylinder that is in a compression stroke.

13. The engine fuel injection control method as recited in claim 12, wherein
upon determining that the deceleration rate is equal to or higher than the prescribed deceleration rate and an intake valve of the cylinder that is in the intake stroke is already closed, the fuel injection quantity for the cylinder that is in the exhaust stroke is set larger than the fuel injection quantity for the cylinders that are in non-exhaust strokes, and the fuel injection quantities for the cylinders that are in the non-exhaust strokes are set successively smaller in a following order from largest quantity to smallest quantity: the cylinder that is in the power stroke, the cylinder that is in the compression stroke, and the cylinder that is in the intake stroke.

14. The engine fuel injection control method as recited in claim 13, wherein
upon determining that the deceleration rate is equal to or higher than the prescribed deceleration rate and an intake valve of the cylinder that is in the intake stroke is already closed, the fuel injection quantity for the cylinder that is in the exhaust stroke is set to be substantially equal to the fuel injection quantity that would have been injected into the cylinder that is in the intake stroke if the intake valve had not already been closed, and the fuel injection quantity for the cylinder that is in the power stroke is substantially equal is set to the fuel injection quantity that would have been injected into the cylinder that is in the exhaust stroke if the intake valve had not yet been closed.

15. The engine fuel injection control method as recited in claim 9, wherein
upon determining that the deceleration rate is equal to or higher than the prescribed deceleration rate and an intake valve of the cylinder that is in the intake stroke is not yet closed, the fuel injection quantity for the cylinder that is in the intake stroke is set to become larger as a period of time measured from the determination that the deceleration rate is equal to or higher than the prescribed deceleration rate to when the intake valve close timing is reached becomes shorter.

16. The engine fuel injection control method as recited in claim 9, wherein
the detecting of the deceleration rate is performed based on calculating a rate of change of at least one of the engine rotational speed and an output shaft rotational speed of a transmission.
